(19) United States
(12) Patent Application Publication
(10) Pub. No.: US 2004/0175450 A1
(43) Pub. Date: Sep. 9, 2004

(54) Stereolithographic shaping method and apparatus

(76) Inventors: Kenji Yanagisawa, Nagano-shi (JP); Masatoshi Akagawa, Nagano-shi (JP)

Correspondence Address: Paul & Paul, 2900 Two Thousand Market Street, Philadelphia, PA, 19103, US

(21) Appl. No.: 10/801,436

(22) Filed: Mar. 16, 2004

Related U.S. Application Data
(62) Division of application No. 09/981,055, filed on Oct. 17, 2001.

(30) Foreign Application Priority Data
Oct. 19, 2000 (JP) 2000-319801

(51) Int. Cl. B29C 35/08

(52) U.S. Cl. 425/135; 425/174.4

(57) ABSTRACT

A stereolithographic shaping method used for manufacturing a shaped article on a shaping table, and a stereolithographic shaping apparatus for implementing this stereolithographic shaping method are disclosed. The stereolithographic shaping method includes the steps of coating a liquid optically-curable resin onto the surface of a shaped article under manufacture, irradiating light onto the optically-curable resin to cure a required portion to form an optically-shaped resin layer, and repeating this process to sequentially laminate optically-shaped resin layers. After the shaping table is supported so as to be able to control a posture position of the shaping table in an optional three-dimensional direction, the optically-curable resin is blown onto a shaped article on the shaping table, thereby to coat the surface of the shaped article with the optically-curable resin in a predetermined film thickness. Then, the optically-shaped resin layers are formed by controlling the posture position of the shaping table and by irradiating the light onto the optically-curable resin that has been coated on the surface of the shaped article.

### BACKGROUND OF THE INVENTION

1. Field of the Invention

The present invention relates to a stereolithographic shaping method and, more particularly, to a stereolithographic shaping method for manufacturing a shaped article from an optically-curable resin. The present invention also relates to a stereolithographic shaping apparatus for implementing such a stereolithographic shaping method. The present invention particularly relates to a stereolithographic shaping method and a stereolithographic shaping apparatus for making it possible to execute a stereolithographic shaping according to a curved-surface lamination.

2. Description of Related Art

Recently, a stereolithographic shaping technique, an application of a lithographic technique, has come to be used for designing models of various kinds of products such as electric equipment or the like. The stereolithographic shaping technique is for manufacturing an object of a three-dimensional structure (a shaped article having a steric structure) by forming cured resin layers through exposure of an uncured or semi-cured optically-curable resin to light, and by sequentially laminating these cured resin layers. This has a characteristic that it is also possible to accurately manufacture products that have subtle structures based on design values. Accordingly, it is possible to utilize the stereolithographic shaping technique not only to manufacture models and miniatures at the product development time but also to manufacture actual steric products. Stereolithographic shaping apparatuses that use such a stereolithographic shaping technique have been disclosed in, for example, Japanese Unexamined Patent Publication (Kokai) Nos. 5-237943 and 5-305672.

FIG. 1 shows a conventional method of forming a cubic shaped article by using a conventional stereolithographic shaping apparatus. A liquid optically-curable resin 20 is accommodated in a tank 10, and an elevator 12 that can go up and down in the tank 10 is provided. The optically-curable resin 20 is a resin material having a property that this resin is cured when ultraviolet rays are irradiated onto this resin, such as an ultraviolet curable resin, for example. When laser beams L are irradiated onto this optically-curable resin 20 from a laser unit 14, it is possible to cure the optically-curable resin 20 in an optional shape within a plane of the irradiation of the laser beams L. Upon the curing of the optically-curable resin 20, optically-shaped resin layers 22 are formed.

The elevator 12 is structured to gradually move down from a liquid surface of the optically-curable resin 20 at a constant rate, after an optically-shaped resin layer 22 has been formed based on the irradiation of the laser beams L. As a result, a plurality of optically-shaped resin layers 22 are laminated to form a cubic shaped article having a predetermined shape. More specifically, in the case of forming optically-shaped resin layers 22, after an optically-curable resin 22 has been formed to have a predetermined flat-surface shape, the elevator 12 is lowered by one layer. Then, the surface of the optically-shaped resin layer 22 is smoothed with a slide bar (not shown) to form a distributed thin layer of the optically-curable resin 20 on the surface of the optically-shaped resin layer 22, and the next stereolithographic shaping operation is carried out. FIG. 1 shows a status that the optically-shaped resin layers 22 are laminated on the elevator 12 after repeating the stereolithographic shaping operation.

As explained above, according to the stereolithographic shaping apparatus, it is possible to form a cubic shaped article having an optional shape by sequentially laminating the optically-shaped resin layers 22. Further, it is also possible to form a shaped article having a more complex cubic structure, by building an insert article into the optically-shaped resin layers 22 at the time of laminating these layers.

Accordingly, it is considered possible to apply the stereolithographic shaping apparatus to the manufacture of an electronic product that contains a semiconductor chip, for example. In other words, it is considered possible to build circuit parts like semiconductor chips into shaped articles, and to electrically connect these circuit parts to each other, thereby to form an electronic product having a multi-layer structure. However, in order to utilize the stereolithographic shaping apparatus for the manufacture of such an electronic product, it is necessary to be able to form an optional cubic shape, particularly a curved surface. In the case of building an insert article into a shaped article of optically-shaped resin layers, there is a problem that it is difficult to build an insert article into the shaped article depending on the shape of the insert article, as explained below.

FIG. 2 shows an example of a case where a trapezoidal insert article 30 has been built into a shaped article of optically-shaped resin layers 22. In the case of the insert article 30 in a status shown in FIG. 2, the optically-shaped resin layers 22 are formed up to a portion A before the insert article 30 is built in. Then, the insert article 30 is set to a recess portion of the optically-shaped resin layers 22, and thereafter, the optically-shaped resin layers 22 at a portion B are laminated, thereby finishing the forming. Therefore, this has no particular problem.

However, in the case of an insert article 32 shown in FIG. 12 that is referred to as an example of the present invention below, even if the insert article 32 has been set to a portion A by laminating optically-shaped resin layers 22, it becomes difficult thereafter to accurately laminate the optically-shaped resin layers 22 at a portion B. This is because when the insert article 32 has been set by laminating the optically-shaped resin layers 22 at the portion A, the upper portion of the insert article 32 is stretched from the surface of the optically-shaped resin layers 22. Therefore, at the time of laminating the optically-shaped resin layers 22 at the portion B, a slide bar for spreading a liquid resin 20 thinly is brought into contact with the insert article 32, and consequently it is not possible to smooth the liquid optically-shaped resin layers to have a predetermined thickness.

As explained above, in the case of building an insert article into a shaped article of optically-shaped resin layers by using a conventional stereolithographic shaping apparatus, there is a problem that it is not possible to properly build in the insert article except when the flat surface shapes have gradually larger widths toward the upper layers of the optically-shaped resin layers 22 as shown in FIG. 2 or when the flat-surfaces have the same shapes for all the layers.

### SUMMARY OF THE INVENTION

The present invention aims at solving the above problems in the conventional stereolithographic shaping method and stereolithographic shaping apparatus.

Therefore, an object of the present invention is to provide a stereolithographic shaping method capable of securely building an insert article into a shaped article of optically-shaped resin layers, even if the insert article has a shape that makes it is difficult to properly achieve the building-in according to the conventional stereolithographic shaping method, thereby to make it possible to manufacture various kinds of shaped articles having insert articles built into them.

Further, an object of the present invention is to provide a stereolithographic shaping method that is useful for manufacturing a shaped article that has built-in an insert article having, particularly, a curved-surface structure.

Furthermore, an object of the present invention is to provide a stereolithographic shaping method that is useful for manufacturing an electronic product that has built-in a circuit part like a semiconductor chip.

Furthermore, an object of the present invention is to provide a stereolithographic shaping apparatus that is useful for implementing a stereolithographic shaping method of the present invention.

Moreover, an object of the present invention is to provide a shaped article, that is securely holds a built-in insert article, of optically-shaped resin layers, the insert article having a shape that makes it is difficult to properly achieve building-in according to the conventional stereolithographic shaping method.

In addition, an object of the present invention is to provide a shaped article that has built-in an insert article having a curved-surface structure such as, for example, an electronic product that has built-in a circuit part like a semiconductor chip.

These objects and other objects of the present invention will be easily understood from the following detailed explanation.

According to one aspect of the present invention, the invention resides in a stereolithographic shaping method used for manufacturing a shaped article on a shaping table, the stereolithographic shaping method comprising the steps of coating a liquid optically-curable resin onto the surface of a shaped article under manufacture, irradiating light onto the optically-curable resin, and curing a required portion of the optically-curable resin to form an optically-shaped resin layer, and repeating this process to sequentially laminate optically-shaped resin layers, wherein

the shaping table is supported so as to be able to control a posture position of the shaping table in an optional three-dimensional direction,

the optically-curable resin is blown onto a shaped article on the shaping table, thereby to coat the surface of the shaped article with the optically-curable resin in a predetermined film thickness, and

the optically-shaped resin layers are formed by controlling the posture position of the shaping table and by irradiating the light onto the optically-curable resin that has been coated on the surface of the shaped article.

It is preferable that the stereolithographic shaping method of the present invention further includes the step of building an insert article, having a three-dimensional structure, into the shaped article.

Further, according to this stereolithographic shaping method, while it is possible to advantageously use various kinds of optically-curable resins for forming optically-shaped resin layers, it is more advantageous to use a resin that can be cured with laser beams. Accordingly, in this case, it is preferable to use laser beams for curing the resin.

According to another aspect of the present invention, the invention resides in a stereolithographic shaping apparatus used for manufacturing a shaped article on a shaping table, the stereolithographic shaping apparatus comprising in combination:

a table supporting unit for supporting a shaping table that supports a shaped article, so as to be able to control a posture position of the shaping table in an optional three-dimensional direction;

a coating unit section that is set with the table supporting unit, for controlling a posture position of the shaping table, and blowing a liquid optically-curable resin onto a shaped article formed on the shaping table, thereby to coat the optically-curable resin onto the surface of the shaped article; and

a curved-surface laminating unit section that is set with a table supporting unit that supports a shaped article coated with the optically-curable resin on the surface, for controlling a posture position of the shaping table, irradiating light onto the optically-curable resin that has been coated on the surface of the shaped article, and curing a required portion of the optically-curable resin, thereby forming optically-shaped resin layers.

The stereolithographic shaping apparatus according to the present invention can, preferably, have the following additional unit sections.

For example, it is preferable that the stereolithographic shaping apparatus of the present invention further comprises a cleaning unit section that is set with the table supporting unit, for controlling a posture position of the shaping table, and cleaning an uncured optically-curable resin that has been coated on the surface of the shaped article.

Further, it is preferable that the stereolithographic shaping apparatus of the present invention further comprises a flat-surface laminating unit section that is set with the table supporting unit, for controlling a posture position of the shaping table, coating a liquid optically-curable resin flat on the surface of a shaped article formed on the shaping table, irradiating light onto the optically-curable resin, and curing a required portion of the optically-curable resin, thereby forming optically-shaped resin layers.

Furthermore, it is preferable that the stereolithographic shaping apparatus of the present invention further comprises a conveying unit section for conveying the table supporting unit between adjacent unit sections, between unit sections such as the coating unit section and the curved-surface laminating unit section or the like.

Furthermore, it is preferable that in the stereolithographic shaping apparatus of the present invention, the coating unit section includes:

a set frame for supporting the table supporting unit; a rotation table for supporting the set frame, and rotating the table supporting unit at an optional position within a flat surface; an elevator table for supporting the rotation table, and bringing up and down the table supporting unit to an optional position; and a nozzle for blowing the optically-curable resin onto the shaped article.

Furthermore, it is preferable that, in the stereolithographic shaping apparatus of the present invention, the curved-surface laminating unit section includes:

a set frame for supporting the table supporting unit; a rotation table for supporting the set frame, and rotating the table supporting unit at an optional position within a flat surface; an elevator table for supporting the rotation table, and bringing up and down the table supporting unit to an optional position; and a light irradiating section for irradiating light onto the optically-curable resin that has been coated on the surface of the shaped article.

Furthermore, it is preferable that in the stereolithographic shaping apparatus of the present invention, the cleaning unit section includes:

a set frame provided to be able to go up and down, for supporting the table supporting unit; a cleaning solution spreading section for spraying a cleaning solution toward a shaped article supported by the table supporting unit; and a tank for storing the cleaning solution after cleaning.

Furthermore, it is preferable that in the stereolithographic shaping apparatus of the present invention, the table supporting unit includes:

a base supporting frame; a movable frame that is axially supported by the supporting frame in one pair of opposite frame sections; and a shaping table that is rotatably supported by the other pair of opposite frame sections of the movable frame. Further, it is preferable that in the table supporting unit, the shaping table is detachably supported by the movable frame.

It is preferable that, in the stereolithographic shaping apparatus of the present invention, the optically-curable resin is a resin that can be cured with laser beams, as in the case of the stereolithographic shaping method. Accordingly, it is preferable that a laser light source is provided as a light source for curing the optically-curable resin.

According to still another aspect of the present invention, the present invention resides in a shaped article that has built-in an insert article having a three-dimensional structure that has been manufactured by using the stereolithographic shaping method and apparatus of the present invention.

It is preferable that the shaped article of the present invention is an electronic product that has built-in a circuit part such as a semiconductor chip.

### BRIEF DESCRIPTION OF THE DRAWINGS

FIG. 1 is a cross-sectional view showing a conventional stereolithographic shaping method for manufacturing a shaped article by laminating optically-curable resins to make a flat surface;

FIG. 2 is a cross-sectional view showing a shaped article that has been built in with an insert article by using the conventional stereolithographic shaping method;

FIG. 3 is a front view showing the whole structure of a stereolithographic shaping apparatus relating to the present invention;

FIG. 4 is a top plan view of the stereolithographic shaping apparatus shown in FIG. 3;

FIG. 5 is a top plan view showing a structure of a table supporting unit that has been built into a stereolithographic shaping apparatus;

FIG. 6A is a front view of the table supporting unit shown in FIG. 5;

FIG. 6B is a side view of the table supporting unit shown in FIG. 5;

FIG. 7A is a front view showing a structure of a flat-surface laminating unit section that has been built into a stereolithographic shaping apparatus;

FIG. 7B is a top plan view showing a structure of the flat-surface laminating unit section that has been built into a stereolithographic shaping apparatus;

FIG. 8A is a front view showing a structure of a curved-surface laminating unit section that has been built into a stereolithographic shaping apparatus;

FIG. 8B is a top plan view showing a structure of the curved-surface laminating unit section that has been built into a stereolithographic shaping apparatus;

FIG. 9 is a front view showing a structure of a cleaning unit section and a coating unit section that have been built into a stereolithographic shaping apparatus;

FIG. 10 is a flowchart showing a process of manufacturing a shaped article by using a stereolithographic shaping apparatus;

FIG. 11 is a cross-sectional view showing a method of manufacturing a shaped article by using a stereolithographic shaping apparatus;

FIG. 12 is a cross-sectional view showing a shaped article that has built-in an insert article after using the stereolithographic shaping apparatus shown in FIG. 11;

FIG. 13A is a perspective view showing an insert article that is used for manufacturing a shaped article shown in FIG. 13B;

FIG. 13B is a perspective view showing the shaped article that has built-in the insert article shown in FIG. 13A; and

FIG. 14 is a perspective view showing another shaped article that has built-in an insert article according to the present invention.

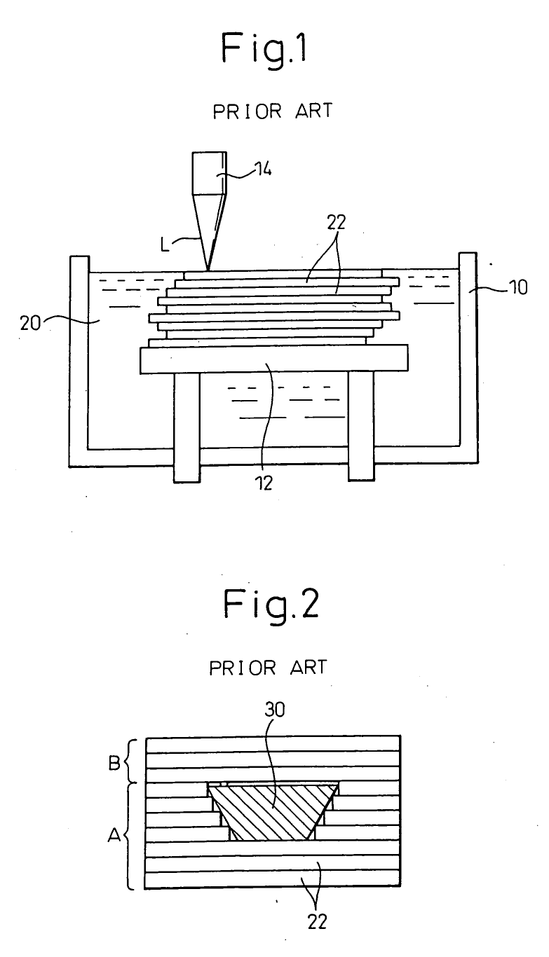

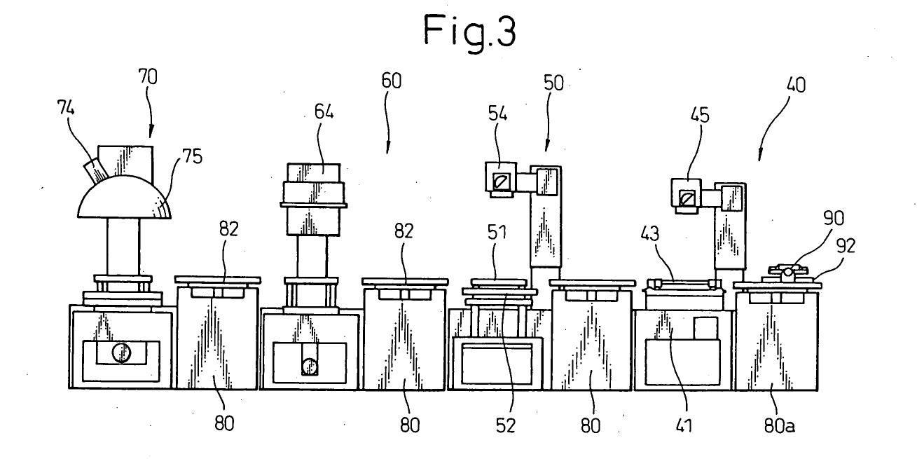

### DESCRIPTION OF THE PREFERRED EMBODIMENTS

Preferred embodiments of the present invention will be explained below. It should be noted that the present invention is not limited to the following embodiments and it is possible to carry out various modifications and improvements within the range of the present invention.

The present invention resides in a shaped article that has built-in an insert article, using a stereolithographic shaping method. In this case, the “stereolithographic shaping method” means a method of manufacturing a shaped article having a three-dimensional structure by irradiating light onto an uncured or semi-cured optically-curable resin and curing this resin thereby to form cured resin layers, and by sequentially laminating these cured resin layers, as briefly explained before. Therefore, this method can also be called a three-dimensional laminating method. Further, in order to effectively carry out this method, it is advantageous to use, in combination, known three-dimensional CAD systems for preparing the shape data of a shaped article.

An optically-curable resin and light for curing this resin that are used for implementing the present invention are not particularly limited as far as intended work effects are obtained. However, it is desirable that the resin is liquid in order to facilitate the coating work by painting, dipping, blowing, and spraying on the surface of a shaped article and other ground. It is possible to determine an optimum value for the viscosity of a liquid resin according to a kind of a coating method. In the implementation of the present invention, it is most preferable to coat the liquid resin by blowing or spraying.

As optically-curable resins that are suitable for application to the formation of a shaped article, there are epoxy resins, urethane resins, and oxetone resins, although optically-curable resins are not limited to these resins. It is possible to use these resins as a single resin or two or more kinds of resins in combination.

The light that is irradiated to cure a resin can be optionally changed depending on the sensitivity of the optically-curable resin used, that is, the intensity of the curing possibility due to the light. Normally, preferable irradiation light is ultraviolet rays. For the light source, it is possible to advantageously use a commercially available laser unit.

Further, the “shaped article” is not particularly limited, and this includes cubic articles having various kinds of shapes. Preferably, the shaped article of the present invention is a cubic article having a curved surface or other complex profile on its front surface or internal surface. As examples of cubic articles, there are electric appliances, electronic products, automobile parts, and various kinds of electric devices, although cubic articles are not limited to these products. A cubic article may be a part of these products as a casing or a structure part.

Further, it is preferable that a shaped article of the present invention is provided in the form that an insert article has been built into the shaped article. In this case, the “insert article” is not particularly limited, and this includes various kinds of parts that can sufficiently exhibit their using effects when they are built into the shaped articles of the present invention. As suitable insert articles, there are, for example, circuit parts like semiconductor chips, chip capacitors, batteries, lead wires, and high-frequency antenna, machine parts like pipes, bolts and nuts, springs, and reinforcing members, and driving parts like motors, and actuators, although insert articles are not limited to these parts. It is possible to use these insert articles as a single article or two or more kinds of articles in combination.

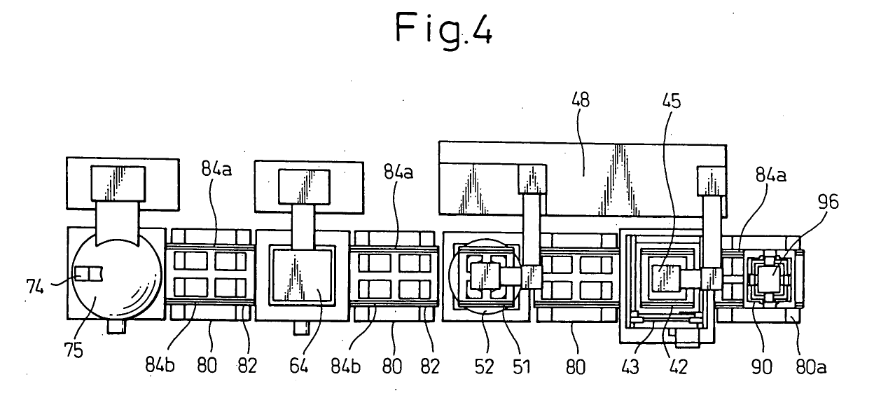

FIG. 3 is a front view showing one preferred embodiment of a stereolithographic shaping apparatus relating to the present invention, and FIG. 4 is a top plan view of the stereolithographic shaping apparatus shown in FIG. 3. In the stereolithographic shaping apparatus shown in the drawings, the order of disposition of unit sections may be changed if necessary.

The illustrated stereolithographic shaping apparatus is equipped with a flat-surface laminating unit section 40 for laminating optically-shaped resin layers to make a flat surface, a curved-surface laminating unit section 50 for laminating optically-shaped resin layers in curved surfaces, a cleaning unit section 60 for cleaning a liquid optically-curable resin, a coating unit section 70 for coating a optically-curable resin by spraying it, and conveying unit sections 80 for conveying a table supporting unit 90 between unit sections. The flat-surface laminating unit section 40, the curved-surface laminating unit section 50, the cleaning unit section 60, and the coating unit section 70 are laid out in series with the conveying unit section 80 disposed between these unit sections respectively as shown in the drawings.

A shaped article (not shown) is formed by sequentially laminating optically-shaped resin layers and integrating them together as described above. In other words, the shaped article is formed while the table supporting unit 90 having a shaping table 96 that becomes a shaping area of the shaped article is being conveyed between the unit sections.

Each conveying unit section 80 has a conveying guide 82 having a common height position with a supporting section that supports the table supporting unit 90 at each unit section, in order to make it possible to transfer the table supporting unit 90 between the unit sections. The conveying unit section 80 is formed to be able to transfer the table supporting unit 90 between the unit sections via the conveying guide 82.

As shown in FIG. 4, the conveying guide 82 has a flat surface shape formed in a rectangular frame shape, and is provided with conveying rails 84a and 84b at both side edge portions of the frame portion (in a direction to connect between adjacent unit sections). A width interval between the two conveying rails 84a and 84b is set common with a width interval of a supporting frame 92 of the table supporting unit 90 so that the table supporting unit 90 can move between the adjacent unit sections via the conveying rails 84a and 84b.

The conveying guide 82 is supported movably in a direction in which the unit sections are laid out in series, that is, in a longitudinal direction. The conveying guide 82 can move between a position for transferring the table supporting unit 90 between the unit sections by proceeding to an adjacent unit section and a position sheltered from an adjacent unit section with a distance.

FIGS. 3 and 4 show a status that the table supporting unit 90 has been set to a conveying unit section 80a for conveying the table supporting unit 90 to the flat-surface laminating unit section 40. This conveying unit section 80a is at a position for setting the shaping table 96 for stereolithographic shaping anew to the table supporting unit 90, and this is also at a position for taking out the shaping table 96 for stereolithographic shaping from the table supporting unit 90 after the stereolithographic shaping has been completed. In other words, as described later, the table supporting unit 90 is formed to detachably support the shaping table 96 for stereolithographic shaping, and is formed to carry out a stereolithographic shaping operation by resetting a new shaping table 96 for stereolithographic shaping each time the stereolithographic shaping operation has been completed.

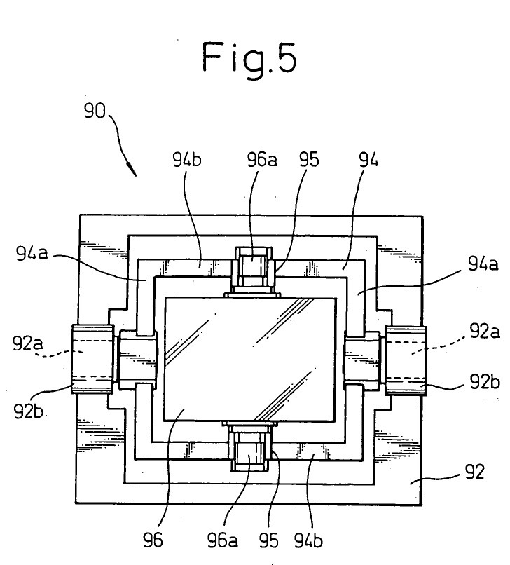

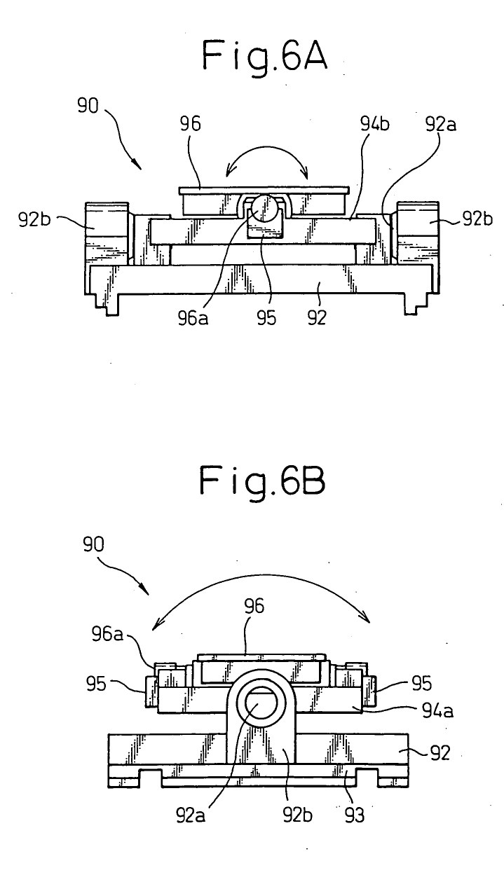

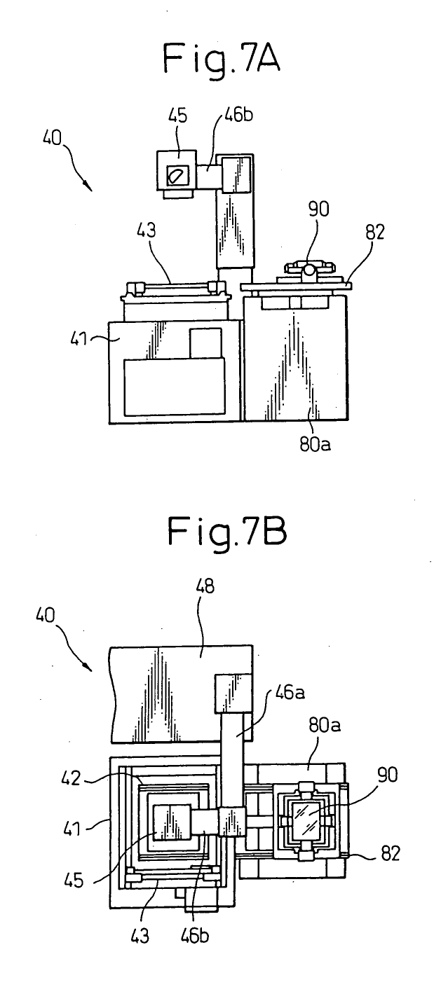

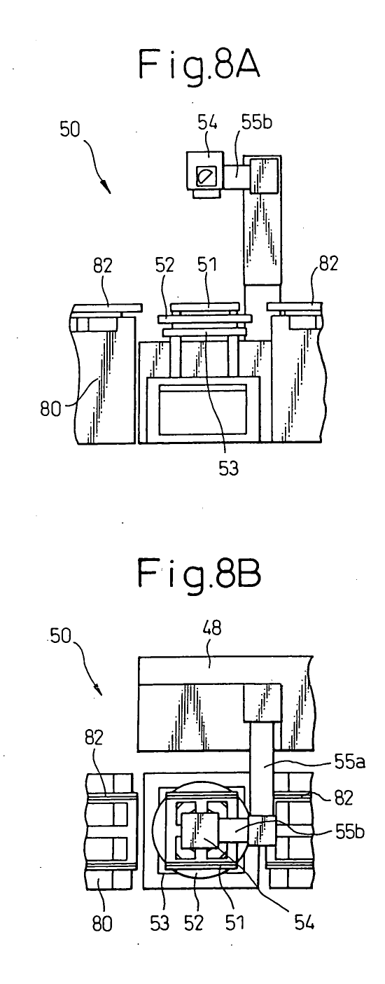

FIG. 5 is a top plan view of the table supporting unit 90 that is used for transferring between the unit sections. In order to explain the operation of this table supporting unit 90, FIGS. 6A and 6B show a front view and a side view of the table supporting unit 90 respectively.

The table supporting unit 90 has the supporting frame 92 formed in a rectangular frame shape that becomes a supporting base of the table supporting unit 90, a rectangular movable frame 94 that is supported by the supporting frame 92, and the shaping table 96 for stereolithographic shaping that is supported by the movable frame 94.

The movable frame 94 has axes 92a formed in a pair of opposite frame sections 94a and 94b of the movable frame 94, axially supported by bearing sections 92b provided on the supporting frame 92, so that the movable frame 94 can oscillate around the axis 92a relative to the supporting frame 92. The two axes 92a and 92a are provided to extend toward the outside from a center position in the longitudinal direction of the two frame sections 94a and 94a of the movable frame 94 respectively. FIG. 6B shows a direction in which the movable frame 94 oscillates around the axis 92a.

The shaping table 96 for stereolithographic shaping is formed in a rectangular plane shape having a flat upper surface, and two supporting axes 96a and 96a are stretched to the outside from both side edges of the shaping table 96. The upper surface of the shaping table 96 becomes a stereolithographic shaping area for forming optically-shaped resin layers.

The two supporting axes 96a and 96a of the shaping table 96 are axially supported by bearings 95 and 95 fitted at a center positions in the longitudinal direction of the other pair of frame sections 94b and 94b of the movable frame 94 respectively. Accordingly, the shaping table 96 can oscillate around the two supporting axes 96a and 96a relative to the movable frame 94. The bearings 95 and 95 fitted to the two frame sections 94b and 94b respectively have an upper portion formed in an arc-shaped receiving section. With this arrangement, it is possible to mount the shaping table 96 on the movable frame 94 from above the movable frame 94 and to dismount the shaping table 96 from the movable frame 94.

The external sizes of the shaping table 96 are set smaller than the internal sizes of the movable frame 94 so that it is possible to oscillate the shaping table 96 at an optional angle around the supporting axes 96a and 96a within the movable frame 94.

As explained above, the movable frame 94 can oscillate in an optional direction relative to the supporting frame 92 via the axes 92a and 92a, and the shaping table 96 can oscillate in an optional direction relative to the movable frame 94 via the supporting axes 96a and 96a. Further, the oscillation direction of the movable frame 94 and the shaping table 96 is deviated by 90°. Therefore, it is possible to direct the plane of the shaping table 96 to an optional direction within the space. When a driving mechanism for rotating the axis 92a by controlling the angle relative to the bearing sections 92b and for rotating the supporting axis 96a by controlling the angle relative to the bearings 95 is provided in the table supporting unit 90, it becomes possible to control to direct the plane of the shaping table 96 to an optional direction. On the lower surface of the supporting frame 92, there is formed a guide rail 93 that is engaged with the above-described conveying rails 84a and 84b of the conveying guide 82.

The table supporting unit 90 has an object of supporting the shaping table 96 for supporting a shaped article to direct the supporting plane of this table to an optional three-dimensional direction, and a structure of the table supporting unit 90 is not limited to the structure of the present embodiment. For example, it is possible to form the flat surface of the shaping table 96 in a circular shape or a trapezoidal shape or the like other than a rectangular shape. Further, according to the method of the present invention, it is possible to form optically-shaped resin layers in a curved-surface lamination. Therefore, the supporting plane of the shaping table 96 is not limited to a flat surface, and it is also possible to form the supporting plane in a curved-surface shape like a waveform, or in a cubic shape like a cylindrical shape, a spherical shape or the like.

Further, the shapes of the movable frame 94 for supporting the shaping table 96 and the like can also be suitably designed to match these shapes of the shaping table 96. Further, a method of detachably supporting the shaping table 96 to the movable frame 94 is not limited to the structure of the above embodiment, and it is also possible to utilize a suitable mounting and dismounting method. Further, in the case of supporting the shaping table 96 to the movable frame 94, and also in the case of supporting the movable frame 94 to the supporting frame 92, it is also possible to support only one frame portion as a single-supporting system.

FIGS. 7A and 7B are enlarged views of the flat-surface laminating unit section 40 of the stereolithographic shaping apparatus shown in FIGS. 3 and 4. The flat-surface laminating unit section 40 is a unit section for forming a shaped article by laminating optically-shaped resin layers to have a flat-surface shape in a similar manner to that of the conventional stereolithographic shaping apparatus. FIG. 7A is a front view and FIG. 7B is a top plan view of the flat-surface laminating unit section 40 respectively.

In these drawings, a reference number 41 denotes a tank for accommodating a liquid optically-curable resin, 42 denotes a set frame for supporting the table supporting unit 90, and 43 denotes a slide bar. The set frame 42 supports the table supporting unit 90, and is provided to be able to move up and down within the tank. On opposite both side edges of the set frame 42, there are provided conveying rails that are similar to those provided on the conveying guide 82.

A reference number 45 denotes a laser irradiating section that incorporates a galvano-mirror. The laser irradiating section 45 is movably supported within the X-Y plane by X-Y arms 46a and 46b, and it is possible to optionally select a position of irradiating laser beams within the X-Y plane. A reference number 48 denotes a laser unit for generating laser beams to cure an optically-curable resin. Laser beams are guided from the laser unit 48 to the laser irradiating section 45 so that the laser irradiating section 45 can irradiate the laser beams.

In the case of carrying out a stereolithographic shaping operation by using the flat-surface laminating unit section 40 shown in the drawings, first, the guide rail 93 of the supporting frame 92 is engaged with the conveying guide 82 of the conveying unit section 80a to set the table supporting unit 90. Next, the set frame 42 is set to the same height position as that of the conveying guide 82, the conveying guide 82 is moved toward the set frame 42, and the conveying guide 82 is brought into contact with the set frame 42. With this operation, the conveying rail of the set frame 42 and the conveying rails 84a and 84b of the conveying guide 82 are in a continuous status. Accordingly, it becomes possible to transfer the table supporting unit 90 to the set frame 42.

After the conveying guide 82 has been returned to the sheltered position, the stereolithographic shaping operation is carried out on the shaping table 96 of the table supporting unit 90 that is supported on the set frame 42. The set frame 42 is lowered within the tank 41, laser beams are irradiated from the laser irradiating section 45 by controlling the liquid surface position of the liquid resin and the front surface position of the shaping table 96, and then the optically-curable resin is cured. Optically-shaped resin layers are sequentially laminated while smoothing the surface, irradiated with the laser beams, by moving the slide bar in parallel with the stereolithographic shaping operation.

In the flat-surface laminating unit section 40, the optically-shaped resin layers are laminated in the flat while holding the shaping table 96 of the table supporting unit 90 at a horizontal position.

FIGS. 8A and 8B are enlarged views of the curved-surface laminating unit section 50 of the stereolithographic shaping apparatus shown in FIGS. 3 and 4. The curved-surface laminating unit section 50 is a unit section for forming optically-shaped resin layers by irradiating laser beams onto the shaping table 96 of the table supporting unit 90 from an optional three-dimensional direction. A reference number 51 denotes a set frame for supporting the table supporting unit 90, 52 denotes a rotation table for supporting the set frame 51, and 53 denotes an elevation table for supporting the rotation table 52. The rotation table 52 supports the set frame 51 by rotating it to an optional direction at an optional angular position within the flat surface, and the elevation table 52 controls the set frame 51 to go up and down at an optional height via the rotation table 52.

At both side edge portions of the set frame 51, conveying rails for guiding the conveyance of the table supporting unit 90 are provided in a similar manner to the set frame 42 in the flat-surface laminating unit section 40 so that it is possible to transfer the table supporting unit 90 between the conveying guides 82 of the adjacent conveying unit sections 80.

As described above, it is possible to control the shaping table 96 supported by the table supporting unit 90 to direct the plane of this table to an optional direction. Therefore, by supporting the table supporting unit 90 to the set frame 51, it is possible to control the posture of the shaping table 96 of the table supporting unit 90 to direct it to an optional direction at an optional height within the space.

A reference number 54 denotes a laser irradiating section that incorporates a galvano-mirror. Laser beams are guided from the laser unit 48 that is used in common with the flat-surface laminating unit section 40, and laser beams are irradiated toward the shaping table 96 of the table supporting unit 90. Reference numbers 55a and 55b denote X-Y arms for movably supporting the laser irradiating unit 54 to an optional position within the X-Y plane.

Based on the supporting mechanism of this laser irradiating section 54, it is possible to irradiate laser beams to an optional position of the shaping table 96 of the table supporting unit 90 that is supported by the set frame 51.

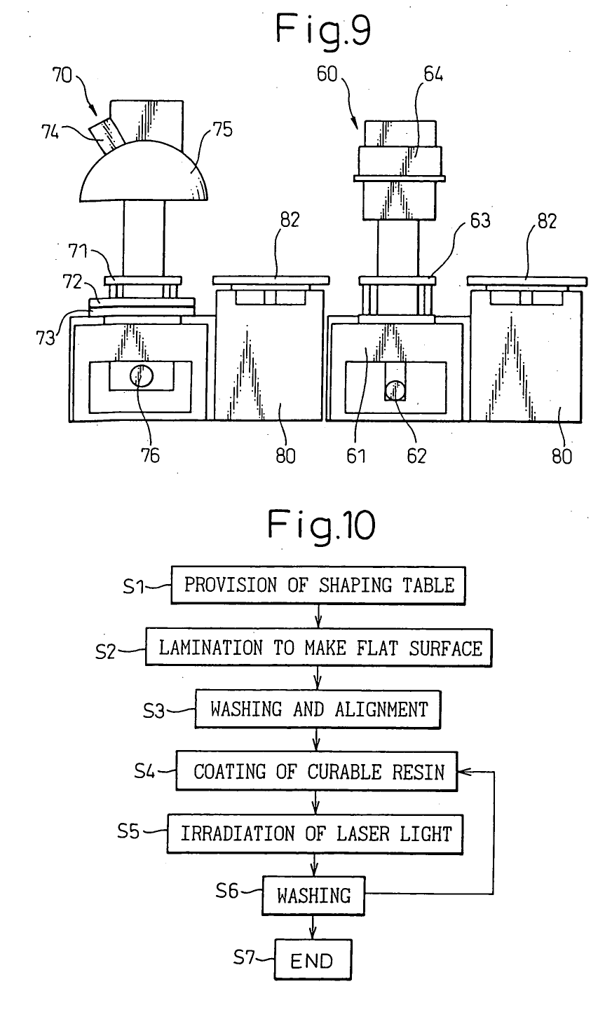

FIG. 9 is an enlarged view of the cleaning unit section 60 and the coating unit section 70 of the stereolithographic shaping apparatus shown in FIGS. 3 and 4. The cleaning unit section 60 is a unit for cleaning a shaped article to remove a liquid resin that remains in an uncured state on the shaped article formed by stereolithographic shaping. A reference number 61 denotes a tank for storing a cleaning solution that has been irradiated toward the table supporting unit 90, 62 denotes a connecting section for connecting between a circulation pump for utilizing a cleaning solution in circulation and the tank 61, and 63 denotes a set frame for supporting the table supporting unit 90. At both side edge portions of the set frame 63, conveying rails for transferring the table supporting unit 90 between the adjacent conveying unit sections 80 are provided. The set frame 63 is supported to be able to go up and down, and it is possible to adjust this to an optional height position.

A reference number 64 denotes a cleaning solution spreading section for discharging a cleaning solution onto a shaped article that has been formed on the shaping table 96 of the table supporting unit 90. The cleaning solution spreading section 64A has a nozzle for discharging a cleaning solution, and is also provided with an image recognizing section (not shown), such as a CCD camera for detecting a position of the shaping table 96 of the table supporting unit 90 and a shape of a shaped article formed on the shaping table 96. The image recognizing section is for accurately measuring a shape of the shaped article, and providing feedback to the subsequent stereolithographic shaping operation.

On the other hand, the coating unit section 70 is a unit section for coating a liquid optically-curable resin onto the shaping table 96 that is supported by the table supporting unit 90 from an optional direction. A reference number 71 denotes a set frame for supporting the table supporting unit 90, 72 denotes a rotation table for rotating the set frame 71 within a horizontal plane, and 73 denotes an elevator table for supporting the rotation table 72. The table supporting unit 90 can be rotated in an optional direction within the horizontal plane based on the rotation table 72, and can be supported at an optional height based on the elevator table 73. At both side edge portions of the set frame 71, conveying rails for transferring the table supporting unit 90 between the adjacent conveying unit sections 80 are provided.

Above the set frame 71, there is disposed a nozzle 74 for discharging an optically-curable resin for stereolithographic shaping. The nozzle 74 is for discharging the optically-curable resin toward the table supporting unit 90. A reference number 75 denotes a hood for preventing the scattering of the optically-curable resin discharged from the nozzle 74, and this hood is provided to cover, in a dome shape, the upper portion of the table supporting unit 90 toward which the liquid resin is discharged. A reference number 76 denotes a resin absorbing mechanism.

In the illustrated coating unit section 70, the table supporting unit 90 supported by the set frame 71 can be rotated in an optional direction within the horizontal plane, and can also be adjusted to an optional height position. At the same time, it is possible to control the posture of the shaping table 96 supported by the table supporting unit 90 to face an optional three-dimensional direction. Therefore, it is possible to blow and coat the optically-curable resin onto the shaped article that is formed on the shaping table 96 from an optional direction. With this arrangement, it becomes possible to coat the optically-curable resin onto the shaped article not only from a flat surface direction but also from an optional direction such as a side surface direction.

Even if it is not possible to smooth the optically-curable resin in a flat shape with a slide bar because a shaped article formed on the shaping table 96 has a complex shape, or even if it is not possible to uniformly coat the optically-curable resin when an insert article has been built into a shaped article, according to the coating unit section 70 of the present embodiment, it is possible to uniformly coat the optically-curable resin onto the plane of the shaped article by scattering the optically-curable resin in a spray shape. As a result, it becomes easy to stereolithographically shape an article having a shape that the conventional stereolithographic shaping apparatus has not been able to achieve.

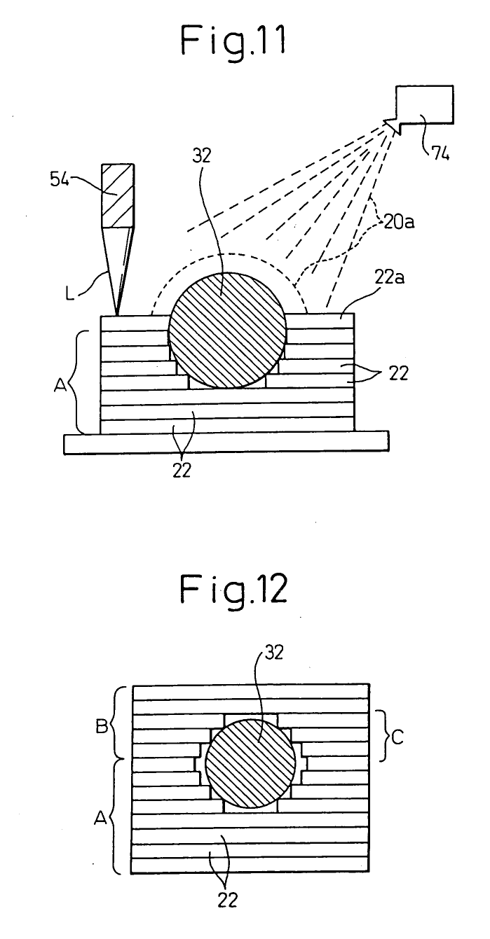

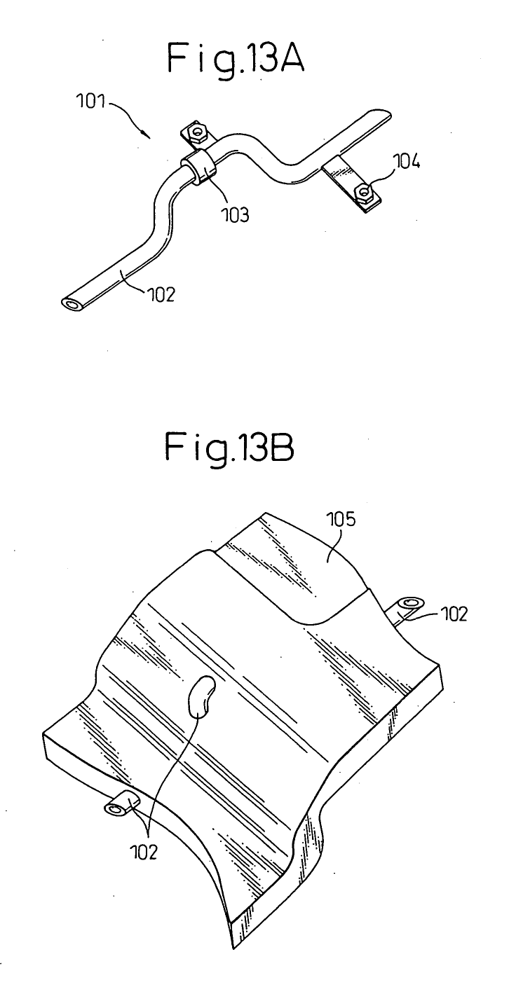

FIG. 10 is a flowchart showing a process of carrying out a stereolithographic shaping operation by using the stereolithographic shaping apparatus shown in FIGS. 3 and 4. FIG. 11 is an approximate cross-sectional view showing an example of manufacturing a shaped article by using the illustrated stereolithographic shaping apparatus. FIG. 12 is a cross-sectional view of a shaped article that has been built in with a manufactured insert article. The method of manufacturing a shaped article shown in FIG. 11 and a method of using the stereolithographic shaping apparatus will be explained below.

In the case of manufacturing a shaped article by using the illustrated stereolithographic shaping apparatus, first, the shaping table 96 that becomes the supporting unit of a shaped article is set to the table supporting unit 90 that has been set to the conveying guide 82 of the conveying unit section 80a at a conveying position of the stereolithographic shaping apparatus (step S1), as shown in FIGS. 3 and 4. As described above, the shaping table 96 can be detachably supported by the table supporting unit 96, and it is possible to mount the shaping table 96 on the table supporting unit 90 by positioning the supporting axes 96a to the bearings 95 of the movable frame 94.

Step S2 is a process of laminating optically-shaped resin layers to make a flat surface. In the example shown in FIG. 11, in order to built a spherical insert article 32 into a shaped article, first, optically-shaped resin layers 22 are surface laminated on the surface of the shaping table 96. The operation of surface laminating the optically-shaped resin layers 22 is carried out by the flat-surface laminating unit section 40. The method of surface laminating the optically-shaped resin layers by the flat-surface laminating unit section 40 can be carried out in a manner similar to that for carrying out the surface lamination by using the stereolithographic shaping apparatus that has conventionally been used in general. In other words, the table supporting unit 90 supported by the set frame 42 is lowered within the tank 41 that stores the liquid optically-curable resin. Then, while stepwise lowering the shaping table 96 from a liquid surface position of the liquid resin, laser beams L are irradiated onto portions of the liquid resin that are to be cured for each layer, and the resin is cured, thereby laminating the optically-shaped resin layers 22.

In FIG. 11, a portion A is a portion of laminating the optically-shaped resin layers 22 to make a flat surface. A range of irradiating the laser beams L is controlled at the time of forming each optically-shaped resin layer 22 so as to form a recess portion for accommodating the insert article 32. For portions onto which the laser beams L are not irradiated, the liquid resin is not cured, and the recess portion remains in the shaped article.

After the flat-surface lamination has been finished, the cleaning unit section 60 cleans the shaped article to remove the uncured resin that remains on the shaped article (step S3). The table supporting unit 90 is transferred to the cleaning unit section 60 via the adjacent conveying unit sections 80. The cleaning unit section 60 blows a cleaning solution to the shaped article, and removes the uncured resin. This cleaning unit section 60 is provided with the image recognizing section. Therefore, after the shaped article has been cleaned, it is possible to measure the layout position of the shaped article on the shaping table 96 and the shape of this shaped article, and correct the laser irradiation position on the curved-surface lamination or the like based on these data.

In the case of the shaped article shown in FIG. 11, next, the insert article 32 is set into the recess portion formed on the shaped article, and the process shifts to the curved-surface lamination operation (step S4). In the curved-surface lamination operation, first, the coating unit section 70 operates to coat the liquid optically-curable resin onto the shaped article. The table supporting unit 90 is transferred to the coating unit section 70 via the conveying unit section 80. The coating unit section 70 can coat the liquid resin onto the shaped article from an optional direction. In the case of the shaped article shown in FIG. 11, while the upper portion of the insert article 32 stretches from the surface of the optically-shaped resin layers 22 formed by the flat-surface lamination, according to the coating unit section 70, it is possible to coat the liquid resin onto the surface of the shaped article, without interruption, from the insert article 32. By spraying a liquid resin 20a from the nozzle 74, this resin is coated onto the surface of the shaped article in a uniform thickness. Of course, the liquid resin 20a is also coated onto the surface of the insert article substantially uniformly.

After the liquid optically-curable resin has been coated using the coating unit section 70, the table supporting unit 90 is transferred to the curved-surface laminating unit section 50, and the laser beams L are irradiated onto the shaped article from the laser irradiating section 54, thereby to execute the stereolithographic shaping operation (step S5). The stereolithographic shaping operation of the curved-surface laminating unit section 50 is different from the stereolithographic shaping operation of the flat-surface laminating unit section 40, and this stereolithographic shaping operation is for carrying out a stereolithographic shaping by controlling the posture of the shaped article to face an optional three-dimensional direction. Even if the insert article 32 stretches from the surface of the optically-shaped resin layers 22 as shown in FIG. 11, it is possible to carry out the stereolithographic shaping by accurately irradiating the laser beams L onto a required portion.

FIG. 11 shows a status that the laser beams L are not irradiated onto the liquid resin 20a that has been coated on the external surface of the insert article 32 built in the shaped article, but the laser beams L are irradiated from the laser irradiating section 54 onto the liquid resin that has been coated on the surface of the optically-shaped resin layer 22 formed by the flat-surface lamination, and the next optically-shaped resin layer 22a is formed.

According to the stereolithographic shaping operation of the curved-surface laminating unit section 50, it is possible to control the shaping table 96 that supports the shaped article to face an optional three-dimensional direction. Therefore, this stereolithographic shaping operation has a characteristic in that it is possible to achieve a stereolithographic shaping by irradiating the laser beams onto the shaped article from an optional direction at an optional position of the shaped article.

According to this curved-surface laminating unit section 50, it is possible to accurately carry out a stereolithographic shaping without being limited by the shape of an insert article even if the shaped article is formed in a curved shape or even if it is not possible to handle this insert article for insertion according to a normal flat-surface lamination method.

After the optically-shaped resin layers have been formed by irradiating the laser beams with the curved-surface laminating unit section 50 and then by curing the liquid resin, the table supporting unit 90 is transferred to the cleaning unit section 60. Then, a cleaning solution flows onto the shaped article to clean the shaped article thereby removing the uncured liquid resin. Then, after completing the cleaning process, the table supporting unit 90 is transferred to the coating unit section 70. The liquid resin is sprayed onto the surface of the shaped article, and the table supporting unit 90 is transferred again to the curved-surface laminating unit section 50 to carry out the stereolithographic shaping operation.

The stereolithographic shaping operation based on the curved-surface lamination is for executing a required curved-surface lamination by repeating the coating of the liquid resin in the coating unit section 70, the stereolithographic shaping in the curved-surface laminating unit section 50, and the cleaning operation in the cleaning unit section 60.

In the example shown in FIG. 11, it is possible to securely build the insert article 32 into the shaped article by carrying out the above curved-surface lamination operation.

Of course, it is possible to carry out the stereolithographic shaping operation by shifting the operation from a curved-surface lamination to a flat-surface lamination after finishing the stereolithographic shaping by curved-surface lamination. It is possible to suitably select a method of combining a curved-surface lamination with a flat-surface lamination for stereolithographic shaping.

After the shaping according to stereolithographic shaping has been completed, the table supporting unit 90 is returned to the position of the conveying unit section 80a, and the shaping table 96 is extracted from the table supporting unit 90. At the same time, a new shaping table 96 is set to the table supporting unit 90 to carry out the next stereolithographic shaping operation (step S7).

As explained above, according to the stereolithographic shaping apparatus of the present embodiment, it is possible to manufacture a stereolithographically-shaped article that has built-in the spherical insert article 32, as shown in FIG. 12, by continuously carrying out the stereolithographic shaping operation.

It is possible to carry out the above-described stereolithographic shaping operation by automatically controlling all the operations including the operation of exchanging and setting the shaping table 96 in the table supporting unit 90, and the operation of setting the insert article in the shaped article. Further, in a similar manner to that of the conventional stereolithographic shaping apparatus, it is possible to obtain a required shaped article by automatically carrying out a required stereolithographic shaping operation based on a design value set in advance.

The stereolithographic shaping apparatus of the above embodiment is structured to be able to select a stereolithographic shaping operation according to flat-surface lamination and a stereolithographic shaping operation according to curved-surface lamination. However, it is of course possible to use the flat-surface laminating unit section 40 as a single unit in the case of carrying out only flat-surface lamination, and it is possible to use only the curved-surface laminating unit section 50 as a single unit in the case of carrying out only curved-surface lamination, for example.

FIGS. 13A and 13B show another example of a shaped article built in with an insert article according to the present invention. These drawings show an example where a hydraulic pipe having a filter has been built into a portion of a protection panel within an automobile engine compartment. As shown in FIG. 13A, a filtered hydraulic pipe 101 consists of a stainless pipe 102 having a diameter of 2 mm. In the middle of the pipe, an oil filter 103 is installed, and a fixing nut 104 is provided. As shown in FIG. 13B, this filtered hydraulic pipe 101 has been built into a protection panel 105 consisting of a decorative panel having a film thickness of 5 mm, according to the present invention. According to this shaped article, the hydraulic pipe that should be disposed at the outside of the protection panel based on the conventional practice has been inserted into the panel. Therefore, it is not only possible to simplify and make compact the total structure, but it is also possible to shorten the manufacturing process and reduce the manufacturing cost.

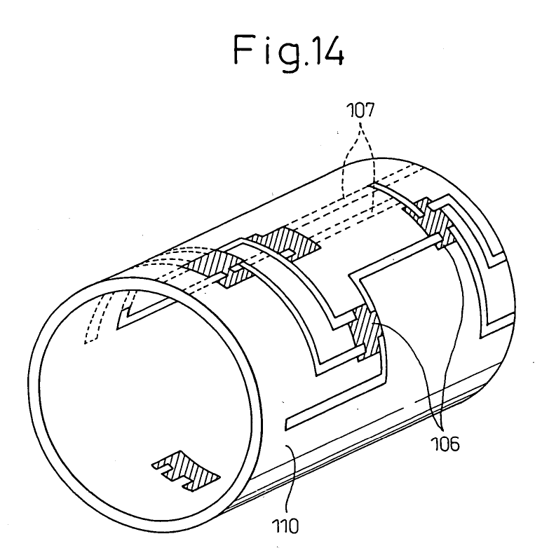

FIG. 14 shows still another example of a shaped article with an insert article built-in according to the present invention. This drawing shows an example of a pole antenna installation part for a portable telephone. The installation part consists of a casing made of an optically-curable resin, a CPU built inside this part, chip capacitors or the like 106, and lead wires 107. As the lower portion of the antenna is structured in this way, it is not only possible to contribute to the compactness of the portable telephone, but it is also possible to prevent problems like the breaking of a wire.

As explained in detail above, according to the stereolithographic shaping method and the stereolithographic shaping apparatus relating to the present invention, a shaping table for supporting a shaped article is provided so as to be able to control the posture of this table in an optional three-dimensional direction, and a liquid resin is blown onto the shaped article supported on this shaping table. Therefore, it is possible to properly coat the surface of the shaped article with the optically-curable resin regardless of a shape of the shaped article and even if an insert article having an optional shape has been built into the shaped article. Further, it is possible to irradiate light for curing the resin, particularly laser beams, from an optional direction. Consequently, it becomes possible to form optically-shaped resin layers in an optional three-dimensional structure. As a result, it is possible to obtain a remarkable effect that it is possible to form a shaped article having a shape that it has not been able to form by the conventional method of laminating optically-shaped resin layers to make a flat surface, or a shaped article built in with an insert article that it has not been possible to achieve according to the conventional practice.

1. A stereolithographic shaping method used for manufacturing a shaped article on a shaping table, the stereolithographic shaping method comprising the steps of coating a liquid optically-curable resin onto the surface of a shaped article under manufacture, irradiating light onto the optically-curable resin, and curing a required portion of the optically-curable resin to form an optically-shaped resin layer, and repeating this process to sequentially laminate optically-shaped resin layers, wherein
the shaping table is supported so as to be able to control a posture position of the shaping table in an optional three-dimensional direction,
the optically-curable resin is blown onto a shaped article on the shaping table, thereby to coat the surface of the shaped article with the optically-curable resin in a predetermined film thickness, and
the optically-shaped resin layers are formed by controlling the posture position of the shaping table and by irradiating the light onto the optically-curable resin that has been coated on the surface of the shaped article.

2. The stereolithographic shaping method according to claim 1, further comprising the step of building an insert article having a three-dimensional structure into the shaped article.

3. The stereolithographic shaping method according to claim 1 or 2, wherein the optically-curable resin is a resin that can be cured with laser beams, and laser beams are used for curing this resin.

4. A stereolithographic shaping apparatus used for manufacturing a shaped article on a shaping table, the stereolithographic shaping apparatus comprising in combination:
a table supporting unit for supporting a shaping table that supports a shaped article, so as to be able to control a posture position of the shaping table in an optional three-dimensional direction;
a coating unit section that is set with the table supporting unit, for controlling a posture position of the shaping table, and blowing a liquid optically-curable resin onto a shaped article formed on the shaping table, thereby to coat the optically-curable resin onto the surface of the shaped article; and
a curved-surface laminating unit section that is set with a table supporting unit that supports a shaped article coated with the optically-curable resin on the surface, for controlling a posture position of the shaping table, irradiating light onto the optically-curable resin that has been coated on the surface of the shaped article, and curing a required portion of the optically-curable resin, thereby forming optically-shaped resin layers.

5. The stereolithographic shaping apparatus according to claim 4, further comprising a cleaning unit section that is set with the table supporting unit, for controlling a posture position of the shaping table, and cleaning an uncured optically-curable resin that has been coated on the surface of the shaped article.

6. The stereolithographic shaping apparatus according to claim 4 or 5, further comprising a flat-surface laminating unit section that is set with the table supporting unit, for controlling a posture position of the shaping table, coating a liquid optically-curable resin flat on the surface of a shaped article formed on the shaping table, irradiating light onto the optically-curable resin, and curing a required portion of the optically-curable resin, thereby forming optically-shaped resin layers.

7. The stereolithographic shaping apparatus according to claim 4 or 5, further comprising a conveying unit section for conveying the table supporting unit between adjacent unit sections, between unit sections such as the coating unit section and the curved-surface laminating unit section or the like.

8. The stereolithographic shaping apparatus according to claim 4, wherein
the coating unit section includes:
a set frame for supporting the table supporting unit; a rotation table for supporting the set frame, and rotating the table supporting unit at an optional position within a flat surface; an elevator table for supporting the rotation table, and moving, up and down, the table supporting unit to an optional position; and a nozzle for blowing the optically-curable resin onto the shaped article.

9. The stereolithographic shaping apparatus according to claim 4, wherein
the curved-surface laminating unit section includes:
a set frame for supporting the table supporting unit; a rotation table for supporting the set frame, and rotating the table supporting unit at an optional position within a flat surface; an elevator table for supporting the rotation table, and bringing up and down the table supporting unit to an optional position; and a light irradiating section for irradiating light onto the optically-curable resin that has been coated on the surface of the shaped article.

10. The stereolithographic shaping apparatus according to claim 5, wherein
the cleaning unit section includes:
a set frame, provided to be able to move up and down, for supporting the table supporting unit; a cleaning solution spreading section for spraying a cleaning solution toward a shaped article supported by the table supporting unit; and a tank for storing the cleaning solution after cleaning.

11. The stereolithographic shaping apparatus according to claim 4, wherein
the table supporting unit includes:
a base supporting frame; a movable frame that is axially supported by the supporting frame in one pair of opposite frame sections; and a shaping table that is rotatably supported by the other pair of opposite frame sections of the movable frame.

12. The stereolithographic shaping apparatus according to claim 11, wherein
the shaping table is detachably supported by the movable frame.

13. The stereolithographic shaping apparatus according to claim 4, wherein
the optically-curable resin is a resin that can be cured with laser beams, and a laser light source is provided as a light source for curing the optically-curable resin.

14. The stereolithographic shaping apparatus according to claim 4, wherein
the shaped article has built-in an insert article having a three-dimensional structure.
